(19) United States
(12) Patent Application Publication
(10) Pub. No.: US 2006/0172115 A1
(43) Pub. Date: Aug. 3, 2006

(54) Gas-premeable laminated sheet

(75) Inventor: Fukuichi Miwa, Hiroshima-shi (JP)

Correspondence Address: OLIFF & BERRIDGE, PLC, P.O. BOX 19928, ALEXANDRIA, VA, 22320, US

(73) Assignee: Axis Co., Ltd., Tokyo (JP)

(21) Appl. No.: 11/196,678

(22) Filed: Aug. 4, 2005

(30) Foreign Application Priority Data
Jan. 28, 2005 (JP) 2005-021491

(51) Int. Cl. B32B 3/10

(52) U.S. Cl. 428/137; 428/138

(57) ABSTRACT

A gas-permeable laminated sheet includes a first nonwoven fabric, a polyethylene film and a second nonwoven fabric, the first nonwoven fabric, the polyethylene film and the second nonwoven fabric being laminated in that order, the polyethylene film having a thickness in the range from 5 to 15 μm and including a plurality of gas paths passing through the polyethylene film at areas where the polyethylene film is in contact with the fibers constituting the first nonwoven fabric and/or the second nonwoven fabric and in the vicinities of the areas, the diameter of the cross section of each of the gas paths being 20 μm or less.

### BACKGROUND OF THE INVENTION

1. Field of the Invention

The present invention relates to a gas-permeable laminated sheet impermeable with, for example, fine powders and droplets but permeable with, for example, air and water vapor, the gas-permeable laminated sheet being formed of a three-layer laminated sheet including a first nonwoven fabric, a polyethylene film, and a second nonwoven fabric laminated in that order.

2. Description of the Related Art

Water vapor-permeable sheets subjected to gas-permeable, waterproof treatment, the sheets impermeable with water droplets of, for example, rain but permeable with water vapor generated by sweating, have been developed and widely used in applications for sporting goods, outdoor products, and the like.

For example, a material having a porous microstructure containing open pores produced by drawing polytetrafluoroethylene (fluorocarbon resin) using a special technique has been known (for example, see U.S. Pat. No. 3,953,566). Such a material is produced by compacting fine powders of polytetrafluoroethylene and then uniaxially or biaxially drawing the resulting compact at high temperature and high speed. Since polytetrafluoroethylene has no hydrophilicity and water absorbency and has a high contact angle with water, the material has high water-repellency. Furthermore, the material has a porous structure containing open pores and is thus permeable with a gas. Consequently, the material has a waterproof property and water-vapor permeability.

Such a conventional gas-permeable sheet requires the above-described special processing and is a special material; hence, the sheet is very expensive. The cost is not so important for sporting goods, outdoor products, which are each required to have a high waterproof property and high permeability to water vapor. However, when the gas-permeable sheet is used for work clothes and the like, the cost becomes a big problem. The work clothes may be contaminated by, for example, paints, chemical agents, and agricultural chemicals during work; therefore, after the work clothes are used one or several times, the work clothes cannot be reused, in some cases. In particular, in working at nuclear facility, special work clothes for protecting the human body from dust contaminated with radioactivity are generally used. The used work clothes can never be reused because of contamination with radioactivity and then must be discarded. It is difficult to use a known gas-permeable sheet for such a usage because of its cost.

### SUMMARY OF THE INVENTION

The present invention has been accomplished in view of the above-described problems. It is an object of the present invention to provide a gas-permeable sheet impermeable with fine powders, such as dust and sand, and droplets of paints, solvents, chemical reagents, insecticides and the like, but permeable with a gas such as air and water vapor, the gas-permeable sheet having satisfactory gas permeability and capable of being produced at low cost from an inexpensive material.

As a result of intensive research, the present inventor found that in a laminated sheet including nonwoven fabrics with a thin polyethylene film provided therebetween, many gas paths passing through the polyethylene film at areas where the polyethylene film was in contact with the fibers constituting the nonwoven fabrics and in the vicinities of the areas were formed by adjusting lamination conditions, the gas path each having a small diameter in cross section. The present inventors confirmed that such a laminated sheet having the gas paths exhibited sufficient gas permeability; the production cost is low; and by drawing the laminated sheet, the gas permeability can be improved. The findings have led to the completion of the present invention.

The present invention relates to a gas-permeable laminated sheet including a first nonwoven fabric, a polyethylene film, and a second nonwoven fabric, the first nonwoven fabric, the polyethylene film, the second nonwoven fabric being laminated in that order, the polyethylene film having a thickness in the range from 5 to 15 μm and including a plurality of gas paths passing through the polyethylene film at areas where the polyethylene film is in contact with the fibers constituting the first nonwoven fabric and/or the second nonwoven fabric and in the vicinities of the areas, the diameter of the cross section of each of the gas paths being 20 μm or less. The present invention also relates to a gas-permeable laminated sheet produced by laminating a first nonwoven fabric, a polyethylene film, and a second nonwoven fabric in that order, and then drawing the resulting laminate in at least one direction, the polyethylene film having a thickness in the range from 5 to 15 μm and including a plurality of gas paths passing through the polyethylene film at areas where the polyethylene film is in contact with the fibers constituting the first nonwoven fabric and/or the second nonwoven fabric and in the vicinities of the areas, the diameter of the cross section of each of the gas paths being 40 μm or less.

The gas-permeable laminated sheet according to the present invention includes gas paths passing through the polyethylene film, the gas paths each having a small diameter in cross section. Therefore, the gas-permeable laminated sheet has gas permeability. In other words, the gas-permeable laminated sheet is impermeable with, for example, fine powders and droplets but permeable with gases. Furthermore, the gas-permeable laminated sheet according to the present invention is formed of inexpensive nonwoven fabrics and a polyethylene film, and requires no special processing, thus resulting in low production cost. Consequently, the gas-permeable laminated sheet according to the present invention is preferably used for applications for which a conventional gas-permeable sheet cannot be used because of high cost. In particular, the gas-permeable laminated sheet according to the present invention is preferably used as a material for work clothes used for, for example, coating works, spraying works of agricultural chemicals, and works at nuclear facility.

The gas-permeable laminated sheet according to the present invention produced by further drawing a laminate including nonwoven fabrics and a polyethylene film has gas paths each having an extended diameter in cross section and can thus achieve higher gas permeability.

### BRIEF DESCRIPTION OF THE DRAWINGS

FIG. 1 is a schematic view showing a laminated structure of a gas-permeable laminated sheet produced in Example 1;

FIG. 2 is an optical-microscope image (100×) of a surface of the polyethylene film after producing the gas-permeable laminated sheet; and

FIG. 3 is a schematic view of the surface state of the polyethylene film on the basis of FIG. 2.

### DESCRIPTION OF THE PREFERRED EMBODIMENTS

The type and thickness of a nonwoven fabric constituting a gas-permeable laminated sheet according to the present invention is not particularly limited. The nonwoven fabric composed of, for example, rayon, nylon, a polyester, an acrylic resin, a polyethylene, a polypropylene, a vinylon, or cupra can be used. The nonwoven fabric composed of a polyester, a polypropylene, or an acrylic resin is particularly preferable. The gas-permeable laminated sheet according to the present invention includes a first nonwoven fabric and a second nonwoven fabric. The first and second nonwoven fabrics may be composed of the same material or not.

The gas-permeable laminated sheet according to the present invention includes a polyethylene film interposed between the first nonwoven fabric and the second nonwoven fabric, the polyethylene film having a thickness of 5 to 15 μm. If the thickness of the polyethylene film is above 15 μm, the number of gas paths passing through the polyethylene film is decreased, thereby reducing gas permeability. On the other hand, if the thickness of the polyethylene film is below 5 μm, the strength of the polyethylene film is reduced. Particularly preferably, the polyethylene film has a thickness of 10 μm or less.

The gas-permeable laminated sheet according to the present invention includes many gas paths passing through the polyethylene film. The gas paths each have a diameter in cross section such that the gas paths are impermeable with dust, droplets, and the like but permeable with a gas such as air and water vapor. The diameter of the cross section of each of the gas paths is, for example, 20 μm or less and preferably 10 to 20 μm. In the gas-permeable sheet according to the present invention, when the nonwoven fabrics and the polyethylene film are laminated, fiber marks are formed on the flexible polyethylene film by the fibers constituting the nonwoven fabrics. Since the fibers are randomly bound, the fiber marks pass through the polyethylene film in some areas to form through holes. The through holes serve as the gas paths. That is, the gas paths are present at areas where the polyethylene film is in contact with the fibers constituting the first nonwoven fabric and/or the second nonwoven fabric and in the vicinities of the areas.

The gas-permeable laminated sheet according to the present invention can be produced as follows: for example, polyethylene is drawn under heating, if necessary, to form a polyethylene film, and then the resulting polyethylene film is laminated with the first and second nonwoven fabrics from both sides of the polyethylene film by adjusting, for example, pressure applied by an upper and lower rollers and the number of revolutions of the upper and lower rollers. However, the production process is not limited to this. A conventinal process for producing a laminated sheet may be used.

When the resulting laminated sheet has insufficient gas permeability, by extending the laminate in one or more directions after lamination, the through holes in the polyethylene film are enlarged, thus improving the gas permeability. The drawing can be performed with, for example, a tenter. The diameter of the cross section of each of the through holes is enlarged to, for example, about 40 μm by drawing.

The resulting gas-permeable laminated sheet according to the present invention can be used for various applications, for example, work clothes, winter clothes, rain wears, sporting goods, and outdoor products, which are required to have impermeability with fine powders and droplets but permeability with gases. In particular, since the gas-permeable laminated sheet according to the present invention is produced at low cost, the gas-permeable laminated sheet is preferably applicable as a material for work clothes used for, for example, civil engineering works, construction works, coating works, spraying works of agricultural chemicals, and works at nuclear facility, which requires disposable work clothes.

When the nonwoven fabrics constituting the gas-permeable laminated sheet according to the present invention are composed of synthetic resins, the gas-permeable laminated sheet is easily recyclable by existing skills. In view of recyclability, the nonwoven fabric is preferably composed of a polyester, a polypropylene, or an acrylic resin. Use of the nonwoven fabric composed of polyethylene eliminates the need for separation of the nonwoven fabric and the polyethylene film in recycling and is thus significantly preferred.

The present invention will be described in detail below based on examples. The present invention is not limited to these examples.

### EXAMPLE 1

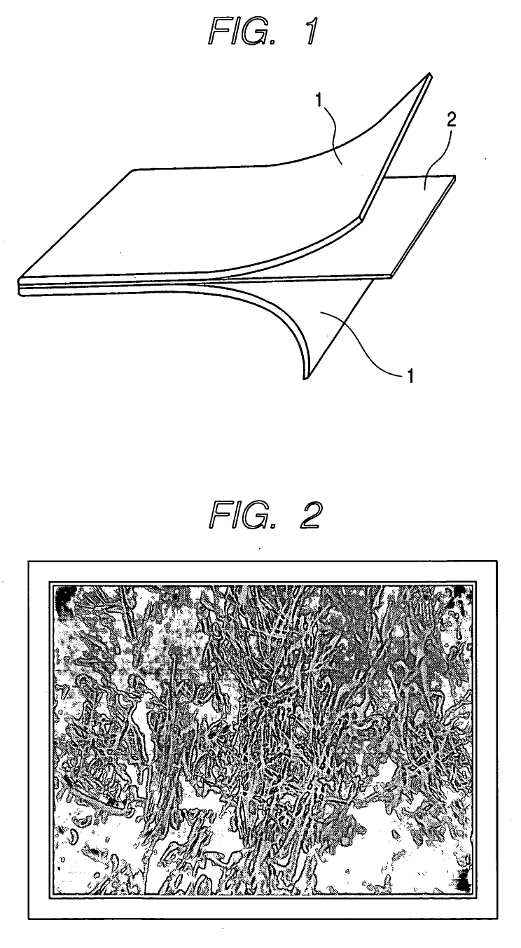

Polyethylene was drawn under heating into a polyethylene film having a thickness of about 15 μm. As shown in FIG. 1, after drawing, nonwoven fabrics 1, each having a thickness of about 30 μm, composed of polyethylene were laminated on upper and lower sides of a polyethylene film 2 so that the polyethylene film 2 was interposed between the nonwoven fabrics 1. The resulting laminate was subjected to pressure-bonding with rollers to produce a gas-permeable laminated sheet according to the present invention. Then, the nonwoven fabrics 1 were carefully peeled off to separate only the polyethylene film 2. The surface state of the polyethylene film 2 was observed with an optical microscope.

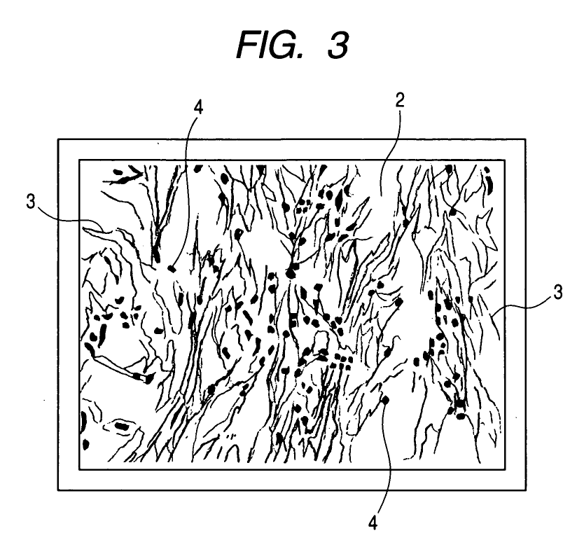

FIG. 2 is an optical-microscope image (100×) of a surface of the polyethylene film after producing the gas-permeable laminated sheet. FIG. 3 is a schematic view of the surface state of the polyethylene film on the basis of FIG. 2.

As shown in FIGS. 2 and 3, on the surface of the polyethylene film 2 after producing the gas-permeable laminated sheet, many fiber marks 3 were formed at areas where the polyethylene film 2 was in contact with the fibers constituting the nonwoven fabrics 1 during lamination of the nonwoven fabrics 1 and the polyethylene film 2, and many through holes 4 were formed in the fiber marks 3 and in the vicinities of the fiber marks 3. The average diameter of the cross section of the through holes 4 was about 10 to 15 μm. It was clear that the gas-permeable laminated sheet produced in Example 1 had gas paths each having a suitable diameter in cross section.

### EXAMPLE 2

Nonwoven fabrics, each having a thickness of about 30 μm, composed of polyethylene were laminated on upper and lower sides of a polyethylene film having a thickness of about 15 μm so that the polyethylene film was interposed between the nonwoven fabrics as in Example 1. The resulting laminated sheet was drawn in the two directions with a tenter to produce a gas-permeable laminated sheet according to the present invention.

Then, in the obtained gas-permeale laminated sheet, the nonwoven fabrics were carefully peeled off to separate the polyethylene film. The surface state of the polyethylene film was observed with an optical microscope.

As a result of observation, similar to the gas-permeable laminated sheet produced in Example 1, on the surface of the polyethylene film after producing the gas-permeable laminated sheet, many fiber marks were formed at areas where the polyethylene film was in contact with the fibers constituting the nonwoven fabrics during lamination of the nonwoven fabrics and the polyethylene film, and many through holes were formed in the fiber marks and in the vicinities of the fiber marks. The average diameter of the cross section of the through holes was about 25 to 35 μm. It was found that the gas-permeable laminated sheet produced in Example 2 had gas paths each having a more suitable diameter in cross section from the standpoint of gas permeability.

### EXAMPLES 3 AND 4

Nonwoven fabrics composed of polyethylene (METSUKE (the weight of each fabric): 22 g/m²) were laminated on upper and lower sides of a polyethylene film (thickness: about 15 μm) so that the polyethylene film was interposed between the nonwoven fabrics as in the above-described Examples. This three-layer laminate was subjected to pressure-bonding with pressure rollers under appropriate conditions to produce a gas-permeable laminated sheet according to the present invention (Example 3). Alternatively, the three-layer laminate was subjected to pressure-bonding with pressure rollers under appropriate conditions while being drawn with a tenter to produce a gas-permeable laminated sheet according to the present invention (Example 4).

With respect to each of the resulting gas-permeable laminated sheets produced in Examples 3 and 4, water-pressure resistance (mm) according to Japanese Industrial Standard (JIS) L 1092A, air permeability (cm³/cm²/s) according to JIS L 1096A, and water-vapor permeability per 24 hours (g/m²·24 h) according to JIS L 1099A-1 were measured. Table 1 shows the results.

TABLE 1

| | | air | water-vapor |
|---|---|---|---|
| | water-pressure | permeability | permeability |
| | resistance (mm) | (cm³/cm²/s) | (g/m² · 24 h) |
| EXAMPLE 3 | 533 | 0.1 | 1728 |
| EXAMPLE 4 | 400 | 0.2 | 2832 |

As shown in Table 1, although the drawn gas-permeable laminated sheet (Example 4) had slightly lower water-pressure resistance compared with that of the undrawn gas-permeable laminated sheet (Example 3), the level of the water-pressure resistance of the drawn gas-permeable laminated sheet (Example 4) was adequate for practical applications. On the other hand, the air permeability of the drawn gas-permeable laminated sheet (Example 4) was twice that of the undrawn gas-permeable laminated sheet (Example 3). Furthermore, the water-vapor permeability of the drawn gas-permeable laminated sheet (Example 4) was significantly improved compared with that of the undrawn gas-permeable laminated sheet (Example 3). Consequently, the gas-permeable laminated sheet produced by being subjected to pressure-bonding while being drawn was advantageous compared with the undrawn laminated sheet from the standpoint of air permeability. Therefore, this is a more preferred embodiment of the present invention.

What is claimed is:

1. A gas-permeable laminated sheet, comprising:
a first nonwoven fabric;
a polyethylene film; and
a second nonwoven fabric,
the first nonwoven fabric, the polyethylene film, the second nonwoven fabric being laminated in that order, the polyethylene film having a thickness in the range from 5 to 15 μm and including a plurality of gas paths passing through the polyethylene film at areas where the polyethylene film is in contact with the fibers constituting the first nonwoven fabric and/or the second nonwoven fabric and in the vicinities of the areas, the diameter of the cross section of each of the gas paths being 20 μm or less.

2. A gas-permeable laminated sheet produced by laminating a first nonwoven fabric, a polyethylene film, and a second nonwoven fabric in that order, and then drawing the resulting laminate in at least one direction, the polyethylene film having a thickness in the range from 5 to 15 μm and including a plurality of gas paths passing through the polyethylene film at areas where the polyethylene film is in contact with the fibers constituting the first nonwoven fabric and/or the second nonwoven fabric and in the vicinities of the areas, the diameter of the cross section of each of the gas paths being 40 μm or less.
